(19) United States
(12) Patent Application Publication
(10) Pub. No.: US 2003/0150552 A1
(43) Pub. Date: Aug. 14, 2003

(54) Laser welding process for automatic transmission oil filters

(76) Inventors: Bernhard Beer, Waldbrol (DE); Markus Beer, Morsbach (DE)

Correspondence Address: BAKER + HOSTETLER LLP, WASHINGTON SQUARE, SUITE 1100, 1050 CONNECTICUT AVE. N.W., WASHINGTON, DC, 20036-5304, US

(21) Appl. No.: 10/369,759

(22) Filed: Feb. 21, 2003

Related U.S. Application Data
(63) Continuation of application No. 09/778,691, filed on Feb. 7, 2001, now abandoned.

(30) Foreign Application Priority Data
Apr. 27, 2000 (DE) 198 60 357.6

(51) Int. Cl. B32B 31/00

(52) U.S. Cl. 156/272.8

(57) ABSTRACT

The invention is directed to a process for the laser welding of two filter half-trays made of plastic and used in automatic transmission oil filters, wherein two filter half-trays are placed one on top of the other and welded along their common edge using laser light, one filter half-tray consisting of laser light-permeable plastic and the other filter half-tray of laser light-impermeable plastic, and the laser beam is passed through the laser light-permeable filter half-tray along the position of contact with the other filter half-tray, striking the -laser light-impermeable filter half-tray, and co-fusing of the two filter half-trays within the welding zone is achieved by light absorption of the laser light-impermeable plastic material.

### I. INTRODUCTION

This invention is directed to a process for the laser welding of two filter half-trays made of plastic and used in automatic transmission oil filters.

### II. BACKGROUND OF THE INVENTION

According to the prior art, the production process for automatic transmission oil filters basically can be divided into two groups. In one production process, the automatic transmission oil filters are designed as a composite construction, comprised of two filter half-trays made of different materials, the one of plastic and the other of metal. The filter medium is clamped between the two filter half-trays. Subsequently, the metal half-tray is enclosed relatively tightly within the edge area around the plastic half-tray by crimping. Due to the dissimilar materials, efforts are high under thermal exposure to achieve function with respect to tightness and dimensional stability throughout the service life of the filter.

In the second production process, automatic transmission oil filters are produced in an all-plastic design. The filter medium is clamped between the two filter half-trays, and the two filter half-trays are assembled by welding where the two filter half-trays in a friction welding process are rubbed against each other until melting of the plastic material takes place in the contact area near the edge, and the trays are welded by applying a compressing force. According to prior art, various variants of the welding process are used, particularly vibratory friction welding, orbital vibratory friction welding, circular vibratory friction welding, or welding by means of ultra-sound.

The drawbacks in these processes are low production rates, problems with respect to tightness, and circular jamming of the filter medium along the entire edge of both filter half-trays. Moreover, the above-described welding processes are abrasive welding processes. As a consequence, massive lateral waste occurs during welding, and the abrasion produced must be accounted for in the construction of transmission oil filters, because otherwise, leakages will result. The present invention therefore provides an improved non-abrasive welding process for all-plastic transmission oil filters.

Thus, the technical object of the invention is to provide a new process for producing automatic transmission oil filters made of plastic, which process would avoid the above-mentioned drawbacks.

### III. SUMMARY OF THE INVENTION

Said technical object is accomplished by means of a process for the laser welding of two filter half-trays 1 and 2 made of plastic and used in automatic transmission oil filters, wherein two filter half-trays 1 and 2 are placed one on top of the other and welded along their common edge using laser light, one filter half-tray 1 consisting of laser light-permeable plastic and the other filter half-tray 2 of laser light-impermeable plastic, and the laser beam 8 is passed through the laser light-permeable filter half-tray along the position of contact with the other filter half-tray 2, striking the laser light-impermeable filter half-tray 2, and co-fusing of the two filter half-trays within the welding zone 4 is achieved by light absorption of the laser light-impermeable plastic material.

### IV. DETAILED DESCRIPTION OF THE INVENTION

This process avoids the drawbacks of the prior art methods. By using a well-aimed design of the automatic transmission oil filter for laser light welding, it is possible to achieve very high production rates, meeting the requirement of tightness, and also, in particular, cleanliness within the joint area. The laser light defines the melting zone in welding seam 4 between the two filter half-trays 1 and 2 with high precision. As a result, the welding lateral waste is extremely low. This is a clear advantage over the welding lateral waste in the vibratory welding process which sometimes is extremely severe.

In a preferred process, a filter 3 is inserted between the filter half-trays 1 and 2 prior to assembling the filter half-trays, which filter in a particularly preferred fashion is held between the two filter half-trays 1 and 2 by means of a clamping rib 5. Either a bag filter or a single-layered filter is used as filter medium 3.

Preferably, the process is performed in such a way that the edge to be welded in a circumferential fashion, where the two filter half-trays 1 and 2 contact each other, is exposed to pressure in a circumferential fashion along the contour of the components. In a particularly preferred fashion, a defined contact pressure on the filter half-trays 1 and 2 is maintained via lower tool 7 or upper tool 6 throughout the process.

In another preferred process, the area of the tool where the laser beam is passed through is laser light-permeable.

In a particularly preferred process, a laser selected from the group of neodymium YAG pulsed laser, neodymium YAG continuous wave laser and diode laser is used in the laser welding process.

It is preferred to use filter half-trays made of the same plastic material, the only difference being their pigment content.

The automatic transmission oil filter produced using the laser welding process according to the invention is comprised of two housing halves 1 and 2 which, when assembled, form an interior space. A filter medium 3 of any type is clamped in said interior space so as to meet all the practical requirements related to these components. In order to be capable of using the laser welding process of the invention, the laser beam 8 must be passed through the material of the one filter housing half-tray 1 to welding zone 4. Accordingly, said filter half-tray 1 must consist of laser light-permeable plastic. To allow the laser 8 to take effect in welding zone 4, the energy of the laser beam must be absorbed by the plastic material at this spot. This is accomplished by including a laser light-absorbent pigmentation in the plastic material of the second filter housing half-tray 2, so that absorption of the laser light will take place. The flanges of the two filter housing half-trays are designed so as to make facial contact, and a laser beam 8 is conducted along the position of contact, which laser beam, as a result of light absorption of the one filter half-tray 2, achieves melting and thus, co-fusing of the two filter half-trays 1 and 2.

### V. DESCRIPTION OF DRAWINGS

The process according to the invention will be illustrated in an exemplary fashion with reference to FIGS. 1 and 2.

FIG. 1 shows a cross-sectional side view of the tool during the laser welding process.

FIG. 2 shows a cross-sectional side view of the tool during the laser welding process.

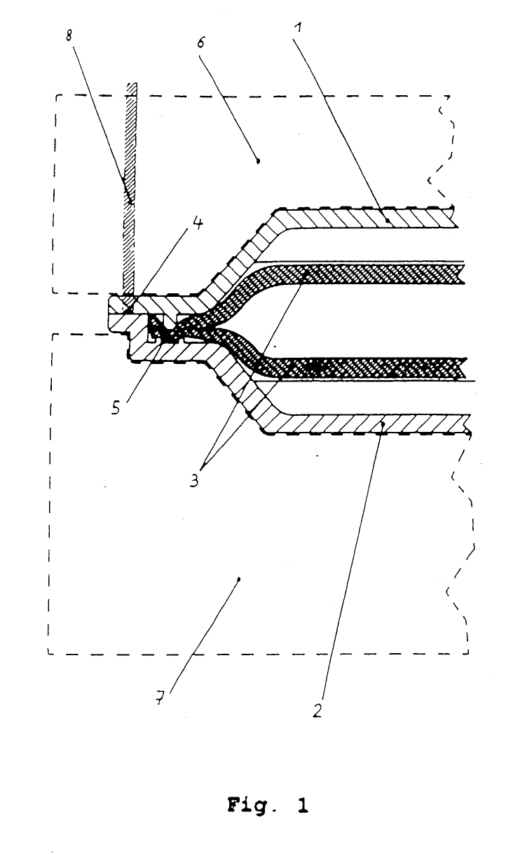

FIG. 1 shows a cross-sectional side view of the tool during the laser welding process. Both filter housing half-trays 1 and 2 are inserted in tool 6 and 7, and the filter medium 3, a bag filter in this case, is clamped between the two half-trays.

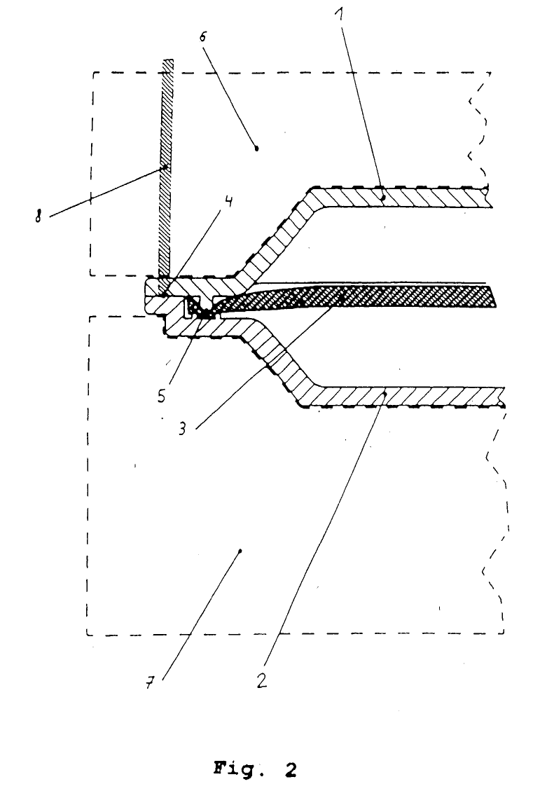

The same view as in FIG. 1 is shown in FIG. 2. In this case, however, a single-layered filter is clamped as filter medium 3 between the two filter half-trays 1 and 2.

The upper filter tray 1 consists of laser light-permeable plastic, and the lower filter tray 2 consists of a laser light-absorbent material. Between these two filter trays 1 and 2, a filter medium 3 is held in position by clamping rib 5. In FIG. 1, said filter medium 3 is a bag filter, while in FIG. 2 the filter medium is a single-layered filter. To allow laser light welding of such automatic transmission oil filters, the edges to be welded in a circumferential fashion are pressed together completely or partially and evenly in a circumferential fashion along the contour of the components. Thus, as a result of the design of hold-down tool 6 and receiving element 7, the welding zone 4 is compressed in a controlled fashion. Throughout the laser light welding period, a constant contact pressure of upper and lower tools 6 and 7 is maintained, which pressure depends on the filter contour, material and distortion of components. To allow introduction of the laser light beam 8 into the welding zone 4 in this design, the upper tool 6 in this area must consist of laser light-permeable material.

Depending on type and design of the filter medium, it is necessary to perform an adjustment between clamping rib 5, filter medium 3 and welding zone 4. That is, the final state of filter medium clamping as in the welded condition is reached already during the pre-assembly, i.e., during pressing together of filter trays 1 and 2. The reason for this is that laser light welding is not an abrasive welding as is e.g. vibratory welding.

The only reason for laser light welding to function is that a precisely circumferential, close contact of both filter half-trays 1 and 2 is produced. The laser absorption of the lower filter tray 2 causes heating of the plastic material up to the melting temperature, and the temperature of the molten material causes the upper filter tray 1 to undergo melting as well and thus, homogeneous co-fusing of the materials. In this way, a well-defined circumferential homogeneous welding seam of the two filter half-trays is achieved within the welding zone 4. Because the base materials of both upper filter tray 1 and lower filter tray 2 are identical, differing only in their coloration, optimum preconditions for a durable and permanently tight fused joint are provided.

1. A process for the laser welding of two filter half-trays (1, 2) made of plastic and used in automatic transmission oil filters, wherein two filter half-trays (1, 2) are placed one on top of the other and welded along their common edge using laser light, one filter half-tray (1) consisting of laser light-permeable plastic and the other filter half-tray (2) of laser light-impermeable plastic, and the laser beam (8) is passed through the laser light-permeable filter half-tray (1) along the position of contact with the other filter half-tray, striking the laser light-impermeable filter half-tray (2), and co-fusing of the two filter half-trays within the welding zone (4) is achieved by light absorption of the laser light-impermeable plastic material, the edges to be welded being pressed into complete contact in a circumferential fashion, and a defined contact pressure on the filter half-trays (1, 2) being maintained during welding via receiving element (7) and/or hold-down tool (6).

2. The process according to claim 1, characterized in that prior to assembling the filter half-trays (1, 2), a filter medium (3) is inserted therein.

3. The process according to claim 2, characterized in that the filter medium is held in position by a clamping rib (5).

4. The process according to claim 2, characterized in that a bag filter or a single-layered filters is used as filter medium (3).

5. The process according to claim 3, characterized in that a bag filter or a single-layered filters is used as filter medium (3).

6. The process according to claim 1, characterized in that the area of the tool where the laser beam is passed through is laser light-permeable.

7. The process according to claim 1, characterized in that a laser selected from the group of neodymium YAG pulsed laser, neodymium YAG continuous wave laser and diode laser is used in the laser welding process.
